(19) United States
(12) Patent Application Publication
(10) Pub. No.: US 2009/0244777 A1
(43) Pub. Date: Oct. 1, 2009

(54) MANUFACTURING METHOD OF MAGNETIC RECORDING MEDIUM

(75) Inventors: Sanae Shimizu, Kawasaki (JP); Yuji Ito, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/256,097

(22) Filed: Oct. 22, 2008

(30) Foreign Application Priority Data
Mar. 26, 2008 (JP) 2008-080736

(51) Int. Cl. G11B 5/60; G11B 5/82; B01J 19/08

(52) U.S. Cl. 360/234; 360/135; 427/526; G9B/5.293; G9B/5.229

(57) ABSTRACT

A disclosed method for manufacturing a magnetic recording medium includes a first step of forming a magnetic recording film on a non-magnetic substrate and a second step of forming, in the magnetic recording film, a magnetic recording region which is magnetically recordable and an isolation region which is magnetically non-recordable and includes a first isolation-region portion and a second isolation-region portion. The second step includes the sub-steps of performing first ion implantation on the magnetic recording film to form the first isolation-region portion along a boundary of the isolation region to be formed with the magnetic recording region to be formed; and performing second ion implantation on the magnetic recording film to form the second isolation-region portion in the surface of the isolation region to be formed.

### CROSS-REFERENCE TO RELATED APPLICATIONS

This application is based upon and claims the benefit of priority of the prior Japanese Patent Application 2008-080736, filed on Mar. 26, 2008, the entire contents of which are incorporated herein by reference.

### FIELD

The disclosures herein are directed to a manufacturing method of a magnetic recording medium, a magnetic recording medium and a magnetic recording/playback device.

### BACKGROUND

HDDs (hard-disk drives) are mainstream mass-storage systems allowing high speed data access and transfer. The surface recording density of HDDs improves nearly 100% on an annual basis, and further improvement in the recording density is sought.

In order to improve the recording density of HDDs, a reduction in track width and recording bit length is necessary. However, if the track width is reduced, adjacent tracks tend to interfere with one another. A reduction in track width likely causes the problem that magnetic recording information is overwritten in adjacent tracks in a recording operation, and the problem that crosstalk occurs due to leakage magnetic fields from adjacent tracks in a playback operation.

Both of the problems trigger a reduction in the S/N ratio of the playback signal and an increase in the error rate. If the recording bit length is progressively reduced, thermal fluctuations are caused, thereby reducing the thermal stability of written bits.

On the other hand, in perpendicular magnetic recording, magnetizations of adjacent bits on a disk medium do not oppose each other, and adjacent bits tend to magnetically reinforce each other. As compared to longitudinal magnetic recording in which magnetizations of adjacent bits oppose each other, perpendicular recording is in principle better suited for higher storage densities, and many manufacturers have already started switching to perpendicular magnetic recording technology.

However, in perpendicular magnetic recording using conventional continuous media, it is difficult to achieve ultrahigh-density recording at 1 Tbpsi or higher. Accordingly, a bit-patterned medium (hereinafter referred to simply as “BPM”), in which a recording film is processed to preliminarily form a bit pattern on a disk, has attracted attention as ultrahigh-density recording technology.

However, creating a magnetic recording medium according to the BPM technology involves highly complicated manufacturing processes, such as etching regions other than bits to remove a magnetic film from these regions and then filling these regions with a non-magnetic material to planarize the surface, in order to stabilize levitation of a magnetic head on the magnetic recording medium. Such complicated manufacturing processes leads to an increase in manufacturing cost.

In order to solve the above problems, a processing method of implanting ions into the magnetic film to thereby locally change the coercivity of the magnetic film has been examined (see Patent Document 1). Since the coercivity is changed by ion implantation, the complex manufacturing processes of etching, filling, planarization and the like are unnecessary, thus preventing an increase in manufacturing cost.

A conventional BPM manufacturing method employing ion implantation uses, for example, a FePt magnetic film having the CuAuI-type ordered structure, which has a high magnetic anisotropy, and locally implants ions into the FePt magnetic film to create regions having low coercivity. According to the conventional method, regions into which ions have been implanted become magnetically non-recordable regions (isolation regions), and regions where no ion implantation has been performed become magnetically recordable regions.

Patent Document 1: Japanese Laid-open Patent Application Publication No. 2005-228912

As described above, in a conventional BPM manufacturing method, recording regions and an isolation region are formed on a magnetic film by selecting a magnetically recordable material as a magnetic film to be formed on a substrate and implanting ions into, other than regions to be the recording regions, the entire region to be the isolation region so as to render it magnetically non-recordable.

In general, the isolation region has a large volume compared to the recording regions. In a conventional BPM manufacturing method, because ions are implanted into the entire region to be the isolation region having a large volume, the ion implantation takes a long period of time, resulting in a reduction in manufacturing efficiency of the magnetic recording media.

### SUMMARY

According to an aspect of the present disclosures, a method for manufacturing a magnetic recording medium includes a first step of forming a magnetic recording film on a non-magnetic substrate and a second step of forming, in the magnetic recording film, a magnetic recording region which is magnetically recordable and an isolation region which is magnetically non-recordable and includes a first isolation-region portion and a second isolation-region portion. The second step includes the sub-steps of performing first ion implantation on the magnetic recording film to form the first isolation-region portion along a boundary of the isolation region to be formed with the magnetic recording region to be formed; and performing second ion implantation on the magnetic recording film to form the second isolation-region portion in the surface of the isolation region to be formed.

According to another aspect of the present disclosures, a magnetic recording medium has, on a magnetic recording film disposed on a non-magnetic substrate, a magnetic recording region and an isolation region magnetically isolating the magnetic recording region. The isolation region includes a magnetically non-recordable first isolation-region portion disposed along a boundary of the isolation region with the magnetic recording region; a magnetically non-recordable second isolation-region portion disposed at a section in the surface of the magnetic recording film, the section being surrounded by the first isolation-region portion; and an internal portion surrounded by the first isolation-region portion and the second isolation-region portion and having the same magnetic property as that of the magnetic recording film.

According to another aspect of the present disclosures, a magnetic recording/playback apparatus includes a magnetic recording medium; a magnetic head configured to perform a magnetic recording/playback process on the magnetic recording medium; an arm configured to support the magnetic head; and a moving unit configured to move the arm. The magnetic recording medium has, on a magnetic recording film disposed on a non-magnetic substrate, a magnetic recording region and an isolation region magnetically isolating the magnetic recording region. The isolation region includes a magnetically non-recordable first isolation-region portion disposed along a boundary of the isolation region with the magnetic recording region; a magnetically non-recordable second isolation-region portion disposed at a section in the surface of the magnetic recording film, the section being surrounded by the first isolation-region portion; and an internal portion surrounded by the first isolation-region portion and the second isolation-region portion and having the same magnetic property as that of the magnetic recording film.

Additional objects and advantages of the embodiment will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1A is a cut-open view of a magnetic recording medium of the first embodiment; FIG. 1B is a plan view of the same;

FIGS. 2A through 2E are cut-open views (part 1) for illustrating a manufacturing method of the magnetic recording medium according to the first embodiment;

FIGS. 3A and 3B are cut-open views (part 2) for illustrating the manufacturing method of the magnetic recording medium according to the first embodiment;

FIGS. 4A through 4F are cut-open views (part 1) for illustrating a manufacturing method of the magnetic recording medium according to the second embodiment;

FIGS. 5A and 5B are cut-open views (part 2) for illustrating the manufacturing method of the magnetic recording medium according to the second embodiment;

FIG. 6 shows magnetic properties of the magnetic recording medium obtained as a condition of ion implantation was changed, along with magnetic properties of Comparative Example; and

FIG. 7 is a plan view of a magnetic recording/playback device according to an embodiment of the present disclosure.

### DESCRIPTION OF EMBODIMENT

Embodiments that describe best modes for carrying out the present disclosures are explained next with reference to the drawings.

### (a) First Embodiment

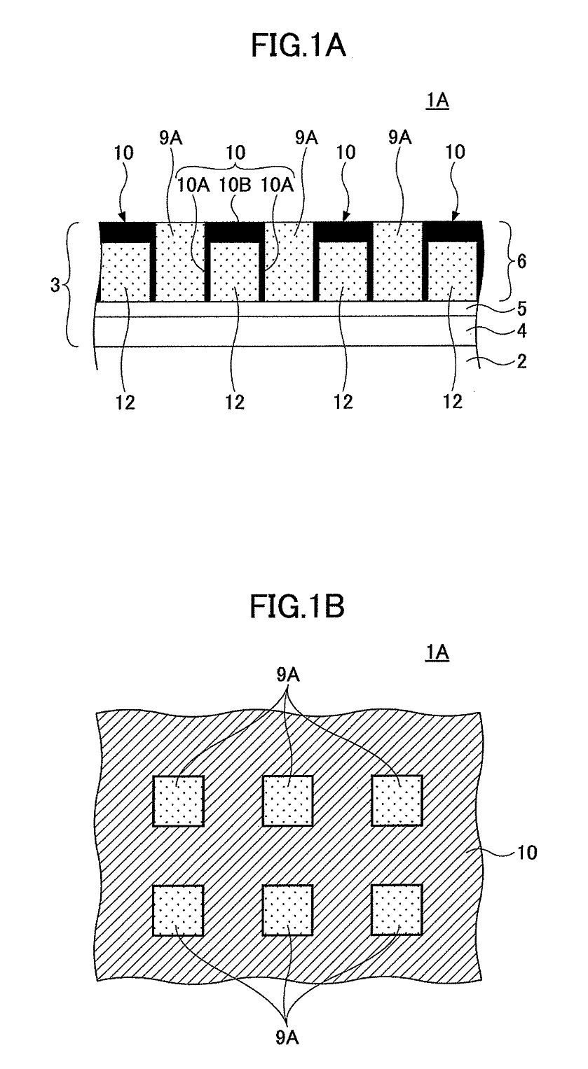

FIG. 1A is a cut-open view of a perpendicular magnetic recording medium 1A (hereinafter referred to as “magnetic recording medium 1A”) of the first embodiment, and FIG. 1B is a plan view of the magnetic recording medium 1A.

As illustrated in FIG. 1A, the magnetic recording medium 1A has a layered structure in which a magnetic recording film 3 is disposed on a non-magnetic substrate 2. The magnetic recording film 3 includes a soft magnetic layer 4, an intermediate layer 5 and a hard magnetic layer 6 that are disposed in that order. On the top surface of the magnetic recording film 3, a protective layer (not illustrated) is formed to protect the hard magnetic layer 6. The magnetic recording medium 1A is used, for example, as a magnetic recording/playback medium of a hard-disk drive (HDD).

The non-magnetic substrate 2 functions as a supporting member of the magnetic recording film 3, and is made of a non-magnetic material, such as glass, aluminum, silicon (Si) or the like. In the present embodiment, a glass plate is used as the non-magnetic substrate 2 (hereinafter referred to as “glass substrate 2”).

On top of the glass substrate 2, the soft magnetic layer 4, which is a component of the magnetic recording film 3, is formed. The soft magnetic layer 4 is a magnetic layer for forming a magnetic closed circuit with a magnetic head, and is made of, for example, an amorphous cobalt (Co) alloy material, such as CoZrNb, CoZrTa, COZrTa, FeCoB or FeCoB.

The soft magnetic layer 4 may have a layered structure in which such a Co alloy material and a non-magnetic layer are disposed one above the other. The soft magnetic layer 4 is preferably made of a high Bs (saturation magnetic flux density) material (1.5 T or more), or FeCoB containing Fe and Co, as major components, at a ratio of 65:35, which allows the highest saturation magnetic flux density. In the present embodiment, a FeCoB layer having a thickness of 25 nm is used as the soft magnetic layer 4.

The intermediate layer 5 functions as an orientation control layer and is provided for improving the crystallinity of the hard magnetic layer 6 disposed on top of the intermediate layer 5. The intermediate layer 5 is formed of, for example, a layered structure in which a Ru layer, a FeCoB layer and a Ru layer are disposed one above the other. In the present embodiment, a layered structure including a Ru layer (0.8 nm in thickness), a FeCoB layer (25 nm) and a Ru layer (10 nm) is used as the intermediate layer 5.

The hard magnetic layer 6 has a magnetic recordable property, and, specifically, has a coercivity of about 5.2 kOe. In the present embodiment, a single layer film made of CoCrPt—SiO₂ having a thickness of 15 nm is used as the hard magnetic layer 6.

As for the protective layer provided on the hard magnetic layer 6, a CN coating sheet, for example, may be used. Note that, the materials and thickness of the soft magnetic layer 4, the intermediate layer 5 and the hard magnetic layer 6 included in the magnetic recording film 3 are not limited to the above-mentioned, and may be selected accordingly.

Here is described the structure of the hard magnetic layer 6. In the hard magnetic layer 6, magnetic recording regions 9A and an isolation region 10 are formed by a manufacturing method to be described below. As shown in FIG. 1B, the recording regions 9A are formed within the isolation region 10 at predetermined intervals. If the magnetic recording medium 1A is used as a medium of a HDD, the recording regions 9A are data recording regions and servo pattern regions.

The isolation region 10 is a region in the hard magnetic layer 6, the magnetic property of which has been modified by ion implantation (to be described below) so as to have a high coercivity (hereinafter referred to as “high-Hc”) or to be non-magnetic. That is, the isolation region 10 is a magnetically non-recordable region. In the hard magnetic layer 6, adjacent magnetic recording regions 9A are magnetically isolated from one another by the isolation region 10.

The isolation region 10 of the present embodiment includes a first isolation region portion 10A, a second isolation region portion 10B and internal regions 12. The first isolation region portion 10A is formed at the boundary between the isolation region 10 and the magnetic recording regions 9A. The first isolation region portion 10A is formed by ion implantation, and therefore has been modified to be magnetically non-recordable. The first isolation region portion 10A is formed throughout the hard magnetic layer 6 in the thickness direction.

In each region surrounded by the first isolation region portion 10A, the second isolation region portion 10B extends in a predetermined depth from the surface of the hard magnetic layer 6. Like the first isolation region portion 10A, the second isolation region portion 10B is formed by ion implantation, and therefore has been modified to be magnetically non-recordable.

Each internal region 12 is a region surrounded by the first isolation region portion 10A and the second isolation region portion 10B. Ion implantation is not performed on the internal regions 12, and therefore the internal regions 12 have substantially the same magnetic property as that of the recording regions 9A. That is to say, the internal regions 12 are magnetically recordable.

However, as described above, the internal regions 12 are surrounded by the high-Hc, or non-magnetic, first and second isolation region portions 10A and 10B. As a result, although having the magnetically recordable internal regions 12 inside, the isolation region 10 magnetically isolates the magnetic recording regions 9A in a reliable manner.

In the magnetic recording medium 1A of the present embodiment, ion implantation is not performed on the entire isolation region 10, but performed only on the first and second isolation region portions 10A and 10B disposed at the perimeter of the internal regions 12. Herewith, as compared to the case of performing ion implantation on the entire isolation region, the magnetic recording medium 1A of the present embodiment requires a reduced amount of ions for the ion implantation.

The thickness (in the right-left direction in FIG. 1A) of the first isolation region portion 10A is preferably in the range of 1 to 5 nm. Also, the thickness (in the up-down direction in FIG. 1A) of the second isolation region portion 10B is preferably in the range of 1 to 5 nm. This is because, if the first and the second isolation region portions 10A and 10B are respectively more than 5 nm in thickness, the amount of ions to be implanted to form the isolation region 10 increases. Also, if the first and the second isolation region portions 10A and 10B are respectively less than 1 nm in thickness, the magnetic recording regions 9A may not be magnetically isolated by the isolation region 10 in a proper manner. However, depending, for example, on the size of the magnetic recording regions, the thickness of each of the isolation region portions 10A and 10B may be in the above-mentioned range.

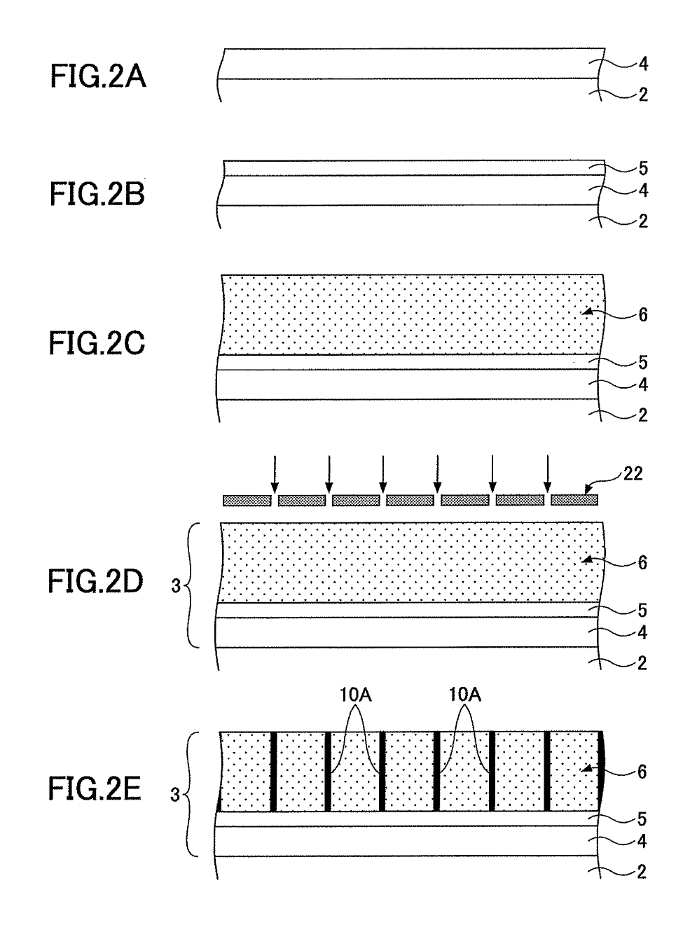

Next is described a method of manufacturing the magnetic recording medium 1A having the above structure. FIGS. 2A through 2E are illustrative drawings for explaining how to manufacture the magnetic recording medium 1A. Note that, in FIGS. 2A through 2E, the same reference numerals are given to the components corresponding to those in FIGS. 1A and 1B, and their explanations are omitted.

To manufacture the magnetic recording medium 1A, first, a FeCoB film having a thickness of 25 nm to be the soft magnetic layer 4 is provided on the glass substrate 1 at an argon (Ar) gas pressure of 0.5 Pa with a sputtering power of 1 kW. In the present embodiment, the soft magnetic layer 4 is a single-layered magnetic backing layer. FIG. 2A shows the soft magnetic layer 4 disposed on top of the glass substrate 2.

The intermediate layer 5 is deposited and formed on the soft magnetic layer 4. The intermediate layer 5 is formed in such a manner that a Ru layer (0.8 nm in thickness) is formed at an Ar gas pressure of 0.8 Pa with a sputtering power of 100 W, then a FeCoB layer (25 nm) is formed on top of the Ru layer at an Ar gas pressure of 0.5 Pa with a sputtering power of 1 kW, and then another Ru layer (10 nm) is formed on top of the FeCoB layer at an Ar gas pressure of 0.8 Pa with a sputtering power 0.3 kW. Thus, in the present embodiment, the intermediate layer 5 has a three-layered structure including the Ru layer, the FeCoB layer and the Ru layer. FIG. 2B shows the intermediate layer 5 disposed on top of the soft magnetic layer 4.

After the formation of the intermediate layer 5 as described above, the hard magnetic layer 6 is deposited and formed on the intermediate layer 5. To form the hard magnetic layer 6, a CoCrPt alloy (15 nm in thickness) is formed on the intermediate layer 5 by sputtering at an Ar gas pressure of 2 Pa with a sputtering power 0.5 kW. FIG. 2C shows the magnetic recording film 3 formed when the hard magnetic layer 6 is provided on the intermediate layer 5 and thereby including the soft magnetic layer 4, the intermediate layer 5 and the hard magnetic layer 6.

At the end, a CN layer (not illustrated) having a thickness of 3 nm is formed on top of the hard magnetic layer 6 as a protective layer. Note that, for an actual use, it is desirable to provide a liquid lubricant layer on top of the protective layer. According to the steps of FIGS. 2A through 2C, the magnetic recording film 3 is formed, in which the soft magnetic layer 4, the intermediate layer 5 and the hard magnetic layer 6 are subsequently disposed on the glass substrate 2.

After the magnetic recording film 3 is formed on the glass substrate 2 as described above, a first mask 22 having openings only at positions corresponding to the first isolation region portion 10A to be formed is placed above the magnetic recording film 3. Then, an ion implantation process (first ion implantation) is performed on the hard magnetic layer 6 through the first mask 22. The ion implantation process is implemented by a publicly-known ion implantation apparatus. FIG. 2D shows the ion implantation carried out on the hard magnetic layer 6.

By adjusting the implantation energy and the like, the ion implantation is carried out such that ions are implanted throughout the hard magnetic layer 6 in the thickness direction. Ions used for the implantation are not particularly limited, provided that they are able to reduce the saturation magnetization of the hard magnetic layer 6. In the present embodiment, Ar ions are used as doping ions. Ions are implanted by sequentially changing the magnitude of the application voltage from 5 keV to 15 keV, and then to 25 keV. The total dose amount is 5×10¹⁵ atoms/cm².

FIG. 2E shows the first isolation region portion 10A formed in the hard magnetic layer 6 (the magnetic recording film 3). The thickness of the first isolation region portion 10A is in the range of 1 to 5 nm, as described above. Note that, at the point when the first ion implantation process is finished, top surface sections of the hard magnetic layer 6, which are surrounded by the first isolation region portion 10A, are not yet modified.

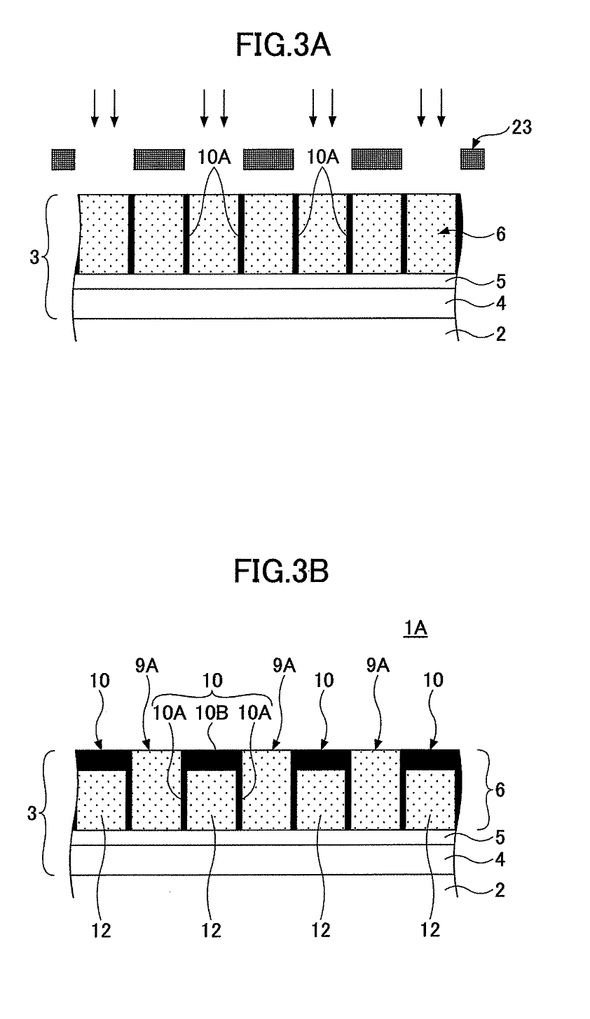

After the first isolation region portion 10A is formed as described above, a second mask 23 is placed above the hard magnetic layer 6. The second mask 23 has openings only at positions surrounded by the first isolation region portion 10A and corresponding to the isolation region 10 to be formed. An ion implantation process (second ion implantation) is performed on the hard magnetic layer 6 through the second mask 23. The ion implantation process is implemented also by a publicly-known ion implantation apparatus. FIG. 3A shows the ion implantation carried out on the hard magnetic layer 6.

By adjusting the implantation energy and the like, the ion implantation is carried out such that ions are implanted into the hard magnetic layer 6 with a predetermined depth from the surface of the hard magnetic layer 6. Ions used for the implantation are not particularly limited, provided that they are able to reduce the saturation magnetization of the hard magnetic layer 6. In the present embodiment, Ar ions are used as doping ions.

The condition for the ion implantation is different from that for forming the first isolation region portion 10A, and ions are implanted by applying a constant voltage of 5 keV, with a total dose amount of 5×10¹⁵ atoms/cm². The reason why the implantation energy of the second ion implantation is small and constant compared to that of the first ion implantation is that, for the formation of the second isolation region portion 10B, ions need to be implanted into the hard magnetic layer 6 up to only a predetermined depth from the surface while, for the formation of the first isolation region portion 10A, ions need to be implanted throughout the hard magnetic layer 6 in the thickness direction.

FIG. 3B shows the second isolation region portion 10B formed in the hard magnetic layer 6 (the magnetic recording film 3). The thickness of the second isolation region portion 10B is in the range of 1 to 5 nm, as described above. The first and the second isolation region portions 10A and 10B are integrally connected. Thus, each internal region 12 is formed within the hard magnetic layer 6 in a manner to be surrounded by the first and the second isolation region portions 10A and 10B.

The magnetic recording medium 1A can be manufactured by implementing the above-mentioned steps. According to the method for manufacturing the magnetic recording medium 1A of the present embodiment, it is unnecessary to carry out ion implantation over the entire extent of the isolation region in order to form the isolation region 10 (i.e. the first and the second isolation region portions 10A and 10B), thereby resulting in a reduction in the ion implantation amount. Accordingly, the time for the ion implantation operations can be shortened, whereby the efficiency of manufacturing the magnetic recording medium 1A can be improved. Also, since the time for the ion implantation to form the isolation region 10 is shortened, influences on the magnetic recording regions 9A by the ion implantation can be reduced, whereby a reduction in magnetic properties of the magnetic recording regions 9A can be prevented.

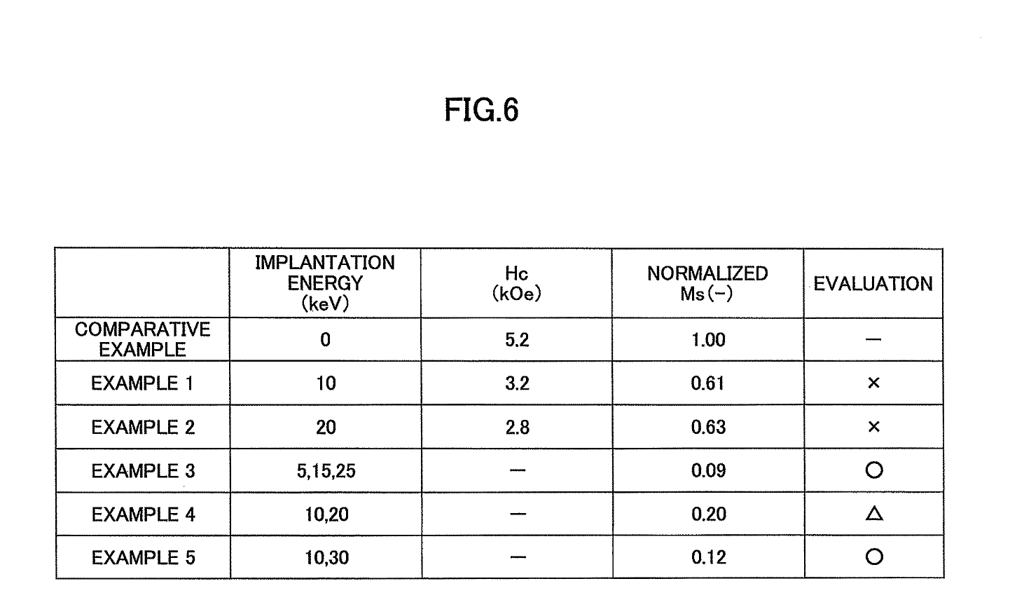

Magnetic properties of the magnetic recording medium 1A manufactured in the above-described manner are explained next with reference to FIG. 6.

FIG. 6 shows results of an experiment to examine the coercivity reduction of the isolation region 10 due to ion implantation. In the experiment, first, a medium (hereinafter referred to as “experimental medium”) was created in which the hard magnetic layer 6 was formed on the glass substrate 2 according to the manufacturing method of the magnetic recording medium 1A described above, and then, the experimental medium was patterned to form a pattern with 10 mm×10 mm squares. Subsequently, ions were implanted into the sections of the pattern according to the manufacturing method of the above first embodiment.

Then, the coercivity (Hc) and saturation magnetization (Ms) were obtained as the number of ion implantation processes was varied. Note that these magnetic properties were evaluated using a vibrating sample magnetometer (VSM).

Comparative Example in FIG. 6 represents the magnetic properties of the hard magnetic layer 6, on which no ion implantation is performed. The coercivity of the hard magnetic layer 6 was 5.2 kOe, which is a value indicating that the hard magnetic layer 6 is magnetically recordable.

Examples 1 and 2 represent the magnetic properties of the hard magnetic layer 6, on the entire extent of which ion implantation was carried out once. Specifically, Example 1 represents the results obtained with an ion implantation energy of 10 keV; and Example 2, 20 keV. In the case of Examples 1 and 2 where ion implantation was performed once on the entire extent of the hard magnetic layer 6, their coercivities were reduced compared to that of Comparative Example; however, magnetic recording could be still performed on Examples 1 and 2, and they were inadequate to be used as the isolation region 10 isolating the magnetic recording regions 9A.

On the other hand, Examples 3 through 5 represent the magnetic properties of the hard magnetic layer 6, on which multiple ion implantation processes were performed in the same manner as the above-described manufacturing method of the magnetic recording medium 1A. In the case of Example 3 where the magnitude of the implantation energy was finely changed (5 keV→15 keV→25 keV), the magnetic properties—both the coercivity and the saturation magnetization—were largely modified, and the implanted region became substantially non-magnetized. Also, in the case of Examples 4 and 5 where the magnitude of the implantation energy was relatively largely changed compared to the case of Example 3, both the coercivity and the saturation magnetization could be modified, and the implanted region became substantially non-magnetized.

### (b) Second Embodiment

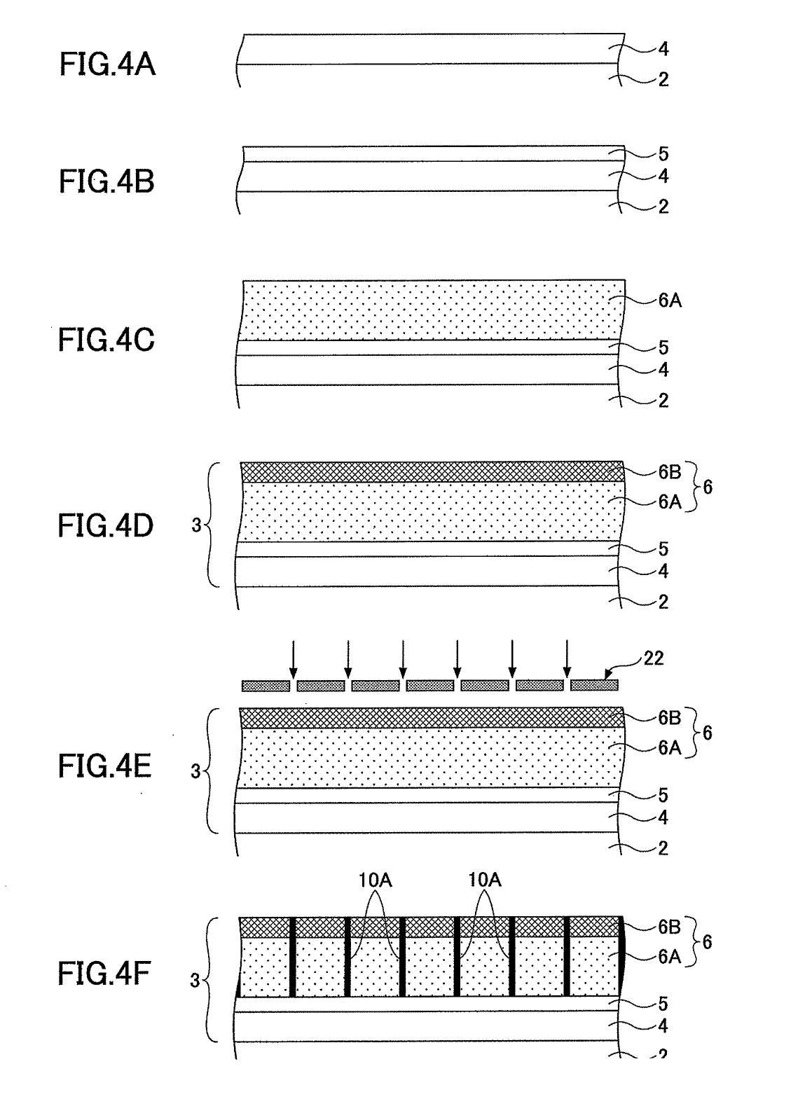

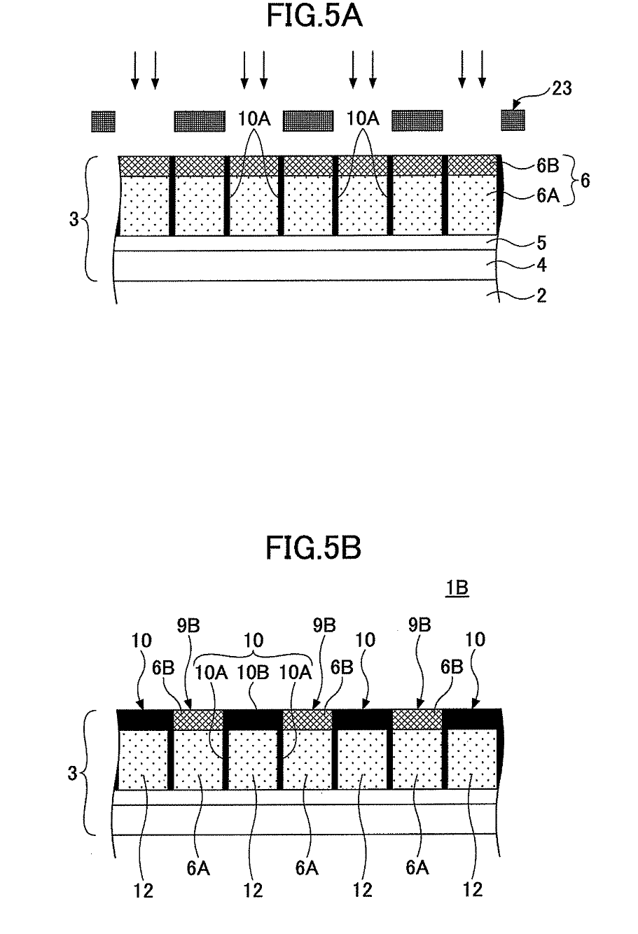

A magnetic recording medium 1B and a method for manufacturing the magnetic recording medium 1B are described next according to the second embodiment with reference to FIGS. 4 and 5. Note that, in FIGS. 4 and 5, the same reference numerals are given to the components corresponding to those in FIGS. 1 through 3, and their explanations are omitted.

FIGS. 3A through 3F are illustrative drawings for explaining how to manufacture the magnetic recording medium 1B. Note that, in FIGS. 3A through 3F, the same reference numerals are given to the components corresponding to those in FIGS. 1A and 1B, and their explanations are omitted.

The magnetic recording medium 1B (see FIG. 5A) according to the present embodiment has substantially the same structure as that of the magnetic recording medium 1A of the first embodiment; however, while the magnetic layer 6 of the magnetic recording medium 1A according to the first embodiment has a single-layered structure, the magnetic layer 6 of the magnetic recording medium 1B according to the present embodiment has a layered structure in which a high-Hc magnetic film 6A and a low-Hc magnetic film 6B are disposed one above the other. The method for manufacturing the magnetic recording medium 1B is described next.

The manufacturing steps of FIGS. 4A through 4C are the same as those illustrated in FIGS. 2A through 2C. That is, the soft magnetic layer 4 and the intermediate layer 5 are sequentially disposed on the glass substrate 2. After the intermediate layer 5 is formed, the high Hc magnetic film 6A is formed on the intermediate layer 5. In the present embodiment, a Co—Pd artificial lattice film is used as a high Hc magnetic film 6A. Note that the high Hc magnetic film 6A is not limited to the Co—Pd artificial lattice film, and an artificial lattice film formed by alternately layering, for example, a Fe film and a Pt film may be used instead.

After the high-Hc magnetic film 6A is formed as described above, the low-Hc magnetic film 6B is subsequently formed on the high-Hc magnetic film 6A. The low-Hc magnetic film 6B is made of the same material as the hard magnetic layer 6 of the first embodiment. The low-Hc magnetic film 6B is, for example, 5 nm in thickness. FIG. 4D shows the magnetic recording film 3 formed when the hard magnetic layer 6 (the high-Hc magnetic film 6A and the low-Hc magnetic film 6B) is provided on the intermediate layer 5 and thereby including the soft magnetic layer 4, the intermediate layer 5 and the hard magnetic layer 6. Then, a protective layer (not illustrated) is formed on the hard magnetic layer 6.

After the magnetic recording film 3 is formed on the glass substrate 2 as described above, the first mask 22 having openings only at positions corresponding to the first isolation region portion 10A to be formed is placed above the magnetic recording film 3. Then, an ion implantation process (first ion implantation) is performed on the hard magnetic layer 6 through the first mask 22. FIG. 4E shows the ion implantation carried out on the hard magnetic layer 6. The conditions of the ion implantation may be the same as those in FIG. 2D.

The first isolation region portion 10A is formed in the hard magnetic layer 6 (the magnetic recording film 3) by the ion implantation. FIG. 4F shows the first isolation region portion 10A formed in the hard magnetic layer 6 (the magnetic recording film 3). Note that, at the point when the first ion implantation process is finished, top surface sections of the hard magnetic layer 6, which are surrounded by the first isolation region portion 10A, are not yet modified.

After the first isolation region portion 10A is formed as described above, the second mask 23 is placed above the hard magnetic layer 6. The second mask 23 has openings only at positions surrounded by the first isolation region portion 10A and corresponding to the isolation region 10 to be formed. An ion implantation process (second ion implantation) is performed on the hard magnetic layer 6 through the second mask 23. The ion implantation process is implemented also by a publicly-known ion implantation apparatus. FIG. 5A shows the ion implantation carried out on the hard magnetic layer 6. The conditions of the ion implantation may be the same as those in FIG. 3A.

FIG. 5B shows the second isolation region portion 10B formed in the hard magnetic layer 6 (the magnetic recording film 3). The thickness of the second isolation region portion 10B is in the range of 1 to 5 nm, as described above. The first and the second isolation region portions 10A and 10B are integrally connected. Thus, each internal region 12 is formed within the hard magnetic layer 6 in a manner to be surrounded by the first and the second isolation region portions 10A and 10B.

Thus, the magnetic recording medium 1B can be manufactured according to the same manufacturing method of the first embodiment even if the hard magnetic layer 6 is made of a layered structure including the high-Hc and low-Hc magnetic films 6A and 6B.

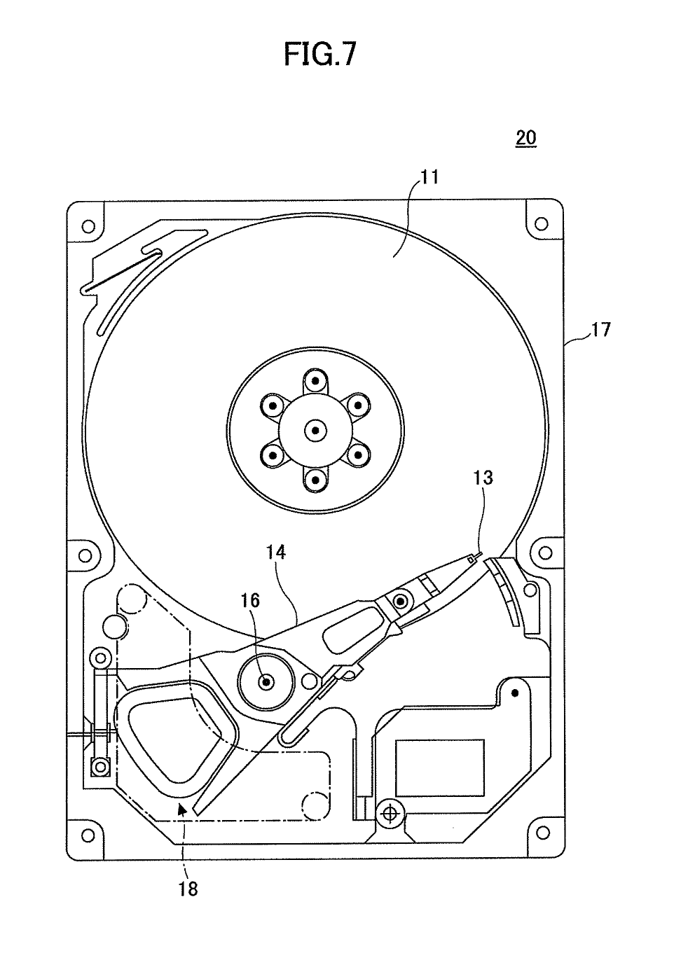

Next is described a magnetic recording/playback device 20 on which the magnetic recording medium 1A of the first embodiment or the magnetic recording medium 1B of the second embodiment may be mounted. FIG. 7 is a plan view of the magnetic recording/playback device 20. The magnetic recording/playback device 20 is a hard-disk device that is installed in a personal computer or a TV recording device.

In the magnetic recording/playback device 20, a magnetic recording medium 11 is housed, as a hard-disk, in a case 17 rotatably by a spindle motor or the like. In the case 17, a carriage arm 14 is provided rotatably by a VCM (voice coil motor) 18 around a shaft 16. A magnetic head 13 is provided at the tip of the carriage arm 14, and writing and reading of magnetic information to/from the magnetic recording medium 11 takes place as the magnetic head 13 scans the surface of the magnetic recording medium 11.

The type of the magnetic head 13 is not particularly limited, and the magnetic head 13 may be formed by a magnetoresistive element, such as a GMR (Giant Magneto-Resistive) element or a TuMR (Tunneling Magneto-Resistive) element. The magnetic recording/playback device 20 is not limited to the above-mentioned hard-disk device, and may be a device for recording magnetic information on a flexible tape-like magnetic recording medium.

Thus, the present disclosures have been described herein with reference to preferred embodiments thereof. While the present disclosures have been shown and described with particular examples, it should be understood that various changes and modification may be made to the particular examples without departing from the scope of the broad spirit and scope of the present disclosures as defined in the claims.

All examples and conditional language used herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made hereto without departing from the spirit and scope of the invention.

What is claimed is:

1. A method for manufacturing a magnetic recording medium, comprising a first step of forming a magnetic recording film on a non-magnetic substrate and a second step of forming, in the magnetic recording film, a magnetic recording region which is magnetically recordable and an isolation region which is magnetically non-recordable and includes a first isolation-region portion and a second isolation-region portion,
wherein the second step includes the sub-steps of:
performing first ion implantation on the magnetic recording film to form the first isolation-region portion along a boundary of the isolation region to be formed with the magnetic recording region to be formed; and
performing second ion implantation on the magnetic recording film to form the second isolation-region portion in a surface of the isolation region to be formed.

2. The method as claimed in claim 1, wherein the first ion implantation is performed such that the first isolation-region portion extends across the magnetic recording film in a thickness direction thereof.

3. The method as claimed in claim 1, wherein an implantation condition of the first ion implantation is different from an implantation condition of the second ion implantation.

4. The method as claimed in claim 3, wherein an implantation energy of the second ion implantation is smaller than an implantation energy of the first ion implantation.

5. The method as claimed in claim 1, wherein the magnetic recording film has a layered structure including a first magnetic recording layer and a second magnetic recording layer that is different from the first magnetic recording layer.

6. The method as claimed in claim 1, wherein a thickness of the first isolation-region portion is in a range between 1 nm and 5 nm, inclusive.

7. The method as claimed in claim 1, wherein a thickness of the second isolation-region portion is in a range between 1 nm and 5 nm, inclusive.

8. A magnetic recording medium having, on a magnetic recording film disposed on a non-magnetic substrate, a magnetic recording region and an isolation region magnetically isolating the magnetic recording region,
wherein the isolation region includes:
a magnetically non-recordable first isolation-region portion disposed along a boundary of the isolation region with the magnetic recording region;
a magnetically non-recordable second isolation-region portion disposed in a surface of the magnetic recording film on an opposite side of the first isolation-region portion from the magnetic recording region; and
an internal portion disposed beneath the second isolation-region portion and separated from the magnetic recording region by the first isolation-region portion, the internal portion having a same magnetic property as the magnetic recording film.

9. The magnetic recording medium as claimed in claim 8, wherein the magnetic recording film has a layered structure including a first magnetic recording layer and a second magnetic recording layer that is different from the first magnetic recording layer.

10. The magnetic recording medium as claimed in claim 8, wherein a thickness of the first isolation-region portion is in a range between 1 nm and 5 nm, inclusive.

11. The magnetic recording medium as claimed in claim 8, wherein a thickness of the second isolation-region portion is in a range between 1 nm and 5 nm, inclusive.

12. The magnetic recording medium as claimed in claim 9, wherein one of the first magnetic recording layer and the second magnetic recording layer is a multi-layered film including a Co film and a Pt film.

13. The magnetic recording medium as claimed in claim 9, wherein one of the first magnetic recording layer and the second magnetic recording layer is a multi-layered film including a Co film and a Pd film.

14. The magnetic recording medium as claimed in claim 12, wherein the other one of the first magnetic recording layer and the second magnetic recording layer is a CoCr-based magnetic film.

15. A magnetic recording/playback apparatus comprising:
a magnetic recording medium having, on a magnetic recording film disposed on a non-magnetic substrate, a magnetic recording region and an isolation region magnetically isolating the magnetic recording region, the isolation region including a magnetically non-recordable first isolation-region portion disposed along a boundary of the isolation region with the magnetic recording region; a magnetically non-recordable second isolation-region portion disposed in a surface of the magnetic recording film on an opposite side of the first isolation-region portion from the magnetic recording region; and an internal portion disposed beneath the second isolation-region portion and separated from the magnetic recording region by the first isolation-region portion, the internal portion having a same magnetic property as the magnetic recording film;
a magnetic head configured to perform a magnetic recording/playback process on the magnetic recording medium;
an arm configured to support the magnetic head; and
a moving unit configured to move the arm.
